(19) United States
(12) Patent Application Publication
(10) Pub. No.: US 2009/0067007 A1
(43) Pub. Date: Mar. 12, 2009

(54) CALIBRATION METHOD AND PRINTING APPARATUS

(75) Inventor: Yuki Ishida, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/205,947

(22) Filed: Sep. 8, 2008

(30) Foreign Application Priority Data
Sep. 10, 2007 (JP) 2007-234711

(51) Int. Cl. H04N 1/60

(52) U.S. Cl. 358/3.23; 358/1.9

(57) ABSTRACT

This invention relates to a method capable of performing labor- and time-saving calibration at high precision, and a printing apparatus to which this method is applied. According to the method, a plurality of patches which are based on achromatic (K) data and have different tone values, and a plurality of patches which are based on chromatic color (C, M, and Y) data and have different tone values are printed. These patches are measured separately for the chromatic and achromatic colors. Chromatic and achromatic color correction tables are separately created to execute calibration. Compared to calibrating C, M, Y, and K, the number of printing media, the coloring material, and the labor of the user can be reduced, and calibration can be performed at higher precision.

### BACKGROUND OF THE INVENTION

1. Field of the Invention

The present invention relates to a calibration method for performing color correction of a printing apparatus whose color characteristics have varied due to individual differences between apparatuses, environmental variations, or the like, and a printing apparatus to which the method is applied.

2. Description of the Related Art

A calibration technique has conventionally been known as a technique for restoring the state of a printing apparatus to a normal one when an output from the printing apparatus varies due to individual differences between apparatuses, environmental variations, or the like. The conventional calibration technique executes calibration processing as follows.

First, a printing apparatus outputs a patch sheet on which a plurality of patches are printed based on predetermined patch image data. On the patch sheet, a plurality of patches are printed by changing the tone value of tonality at predetermined intervals for each of coloring materials (e.g., C (Cyan), M (Magenta), Y (Yellow), and K (blacK) inks) incorporated in the printing apparatus. In some cases, a patch sheet on which patches of all tone values (256 tones) are printed for the respective coloring materials is used. Predetermined calibration processing is executed based on the color values of patches obtained by measuring all patches on the patch sheet by a calorimeter or the like.

For example, Japanese Patent Laid-Open No. 2002-330302 discloses a color adjustment method of a second color printer capable of genuinely reproducing single black color of a first color printer. According to this method, when reproducing and outputting the color of the first color printer from a calibrated the second color printer, quality in a black ink version is almost the same as an actual printed material by the first color printer, and the text quality is well improved.

Japanese Patent Laid-Open No. 2005-184144 discloses a printing apparatus color correction method. According to this method, patches important for performing color correction at a certain precision are printed at earlier positions of the calorimetric sequence. The number of patches to be measured is changed in accordance with the targeted precision, creating a color correction table.

However, the color adjustment method of improving the quality of single black color in Japanese Patent Laid-Open No. 2002-330302 requires a significant amount of labor and time for the user because patches are printed and measured for all combinations of C, M, Y, and K coloring materials.

The color correction method of printing important patches at earlier positions of the calorimetric sequence in Japanese Patent Laid-Open No. 2005-184144 proposes reduction of the number of patches to be measured, in order to reduce the amount of labor for the user. However, the user must determine the measurement order of patches and the number of patches to be measured. It is difficult for the user to determine the measurement order and number of patches for performing color correction which maintains a predetermined or higher precision.

### SUMMARY OF THE INVENTION

Accordingly, the present invention is conceived as a response to the above-described disadvantages of the conventional art.

For example, a calibration method and a printing apparatus using the method according to this invention are capable of performing labor- and time-saving calibration which maintains a predetermined precision.

According to one aspect of the present invention, preferably, there is provided a method of calibrating a printing apparatus which prints an image on a printing medium based on image data, the method comprising: a printing step of printing a plurality of chromatic patches representing different tone values by changing a value of a chromatic component of the image data, and a plurality of achromatic patches representing different tone values by changing a value of an achromatic component of the image data; a calorimetric step of measuring the plurality of chromatic patches and the plurality of achromatic patches printed in the printing step; a correction table creation step of separately creating a there dimensional (3D) chromatic color correction table for correcting differences between calorimetric values obtained from the plurality of chromatic patches measured in the calorimetric step and a preset targeted color value, and a one dimensional (1D) achromatic color correction table for correcting differences between calorimetric values obtained from the plurality of achromatic patches measured in the calorimetric step and a preset targeted color value; a determination step of determining whether or not image data used to print is data formed from chromatic data and achromatic data, or achromatic data; a correction step of correcting the image data used to print by using both the 3D chromatic color correction table and the 1D achromatic color correction table in a case where it is determined in the determination step that the image data used to print is data formed from chromatic data and achromatic data, or by using only the 1D achromatic color correction table in a case where it is determined that the image data used to print is achromatic data; and a printing step of printing an image on a printing medium based on the image data corrected in the correction step.

According to another aspect of the present invention, preferably, there is provided a printing apparatus which performs correction by applying the above calibration method and prints, the apparatus comprising: storage means for storing the 3D chromatic color correction table and the 1D achromatic color correction table; input means for inputting image data from a host computer; determination means for determining whether the image data is data formed from chromatic data and achromatic data, or achromatic data; correction means for performing correction by using the 1D achromatic color correction table and the 3D chromatic color correction table in a case where it is determined by the determination means that the image data is data formed from chromatic data and achromatic data, or by using only the 1D achromatic color correction table in a case where it is determined by the determination means that the image data is achromatic data; conversion means for converting the image data corrected by the correction means into print data corresponding to coloring materials used in the printing apparatus; and printing means for printing by using the print data obtained by the conversion by the conversion means.

According to still another aspect of the present invention, preferably, there is provided a method of calibrating a printing apparatus which prints an image on a printing medium based on image data, the method comprising: a printing step of printing a plurality of chromatic patches representing different tone values by changing a value of a chromatic component of the image data, and a plurality of achromatic patches representing different tone values by changing a value of an achromatic component of the image data; a calorimetric step of measuring the plurality of chromatic patches and the plurality of achromatic patches printed in the printing step; a correction table creation step of separately creating a multidimensional chromatic color correction table for correcting differences between calorimetric values obtained from the plurality of chromatic patches measured in the calorimetric step and a preset targeted color value, and a one dimensional (1D) achromatic color correction table for correcting differences between calorimetric values obtained from the plurality of achromatic patches measured in the calorimetric step and a preset targeted color value; a division step of dividing image data used to print into chromatic data and achromatic data; a correction step of correcting the image data by applying the multidimensional chromatic color correction table to the calorimetric data divided in the division step, and the 1D achromatic color correction table to the achromatic data divided in the division step; and a printing step of printing an image on a printing medium based on the image data corrected in the correction step.

According to still another aspect of the present invention, preferably, there is provided a printing apparatus which performs correction by applying the above calibration method and prints, the apparatus comprising: storage means for storing the multidimensional chromatic color correction table and the 1D achromatic color correction table; input means for inputting image data from a host computer; division means for dividing the image data into chromatic data and achromatic data; correction means for correcting the image data by applying the multidimensional chromatic color correction table to the calorimetric data divided by the division means, and the 1D achromatic color correction table to the achromatic data divided by the division means; conversion means for converting the image data corrected by the correction means into print data corresponding to coloring materials used in the printing apparatus; and printing means for printing an image on a printing medium based on the print data obtained by the conversion by the conversion means.

The invention is particularly advantageous since a plurality of achromatic patches having different tones, and a plurality of chromatic patches having different tones are separately printed and measured to separately create correction tables, and calibration can be performed while maintaining a predetermined precision and greatly decreasing the number of printed patches. As a result, the time and labor for calibration can be greatly saved.

Further features of the present invention will become apparent from the following description of exemplary embodiments with reference to the attached drawings.

### BRIEF DESCRIPTION OF THE DRAWINGS

FIG. 1 is a view showing an outline of a calibration method as a typical embodiment of the present invention;

FIGS. 2 and 3 are perspective views showing the outer appearance of the schematic structure of an inkjet printing apparatus;

FIG. 4 is a functional block diagram of a computer and printing apparatus used to achieve calibration;

FIG. 5 is a flowchart showing correction table generation processing;

FIG. 6 is a view showing the layout of a patch sheet;

FIG. 7 is a view showing the layout of a conventional patch sheet;

FIG. 8 is a flowchart showing correction table application processing;

FIG. 9 is a block diagram showing another arrangement of the functional blocks of the computer and printing apparatus used to achieve calibration;

FIG. 10 is a block diagram showing a data flow associated with processing to apply a correction table to image data formed from chromatic data (C, M, and Y components) and achromatic data (K component); and

FIG. 11 is a flowchart showing the correction table application processing shown in FIG. 10.

### DESCRIPTION OF THE EMBODIMENT

An embodiment of the present invention will now be described in detail in accordance with the accompanying drawings. Note that the same reference numerals are added to constituent elements already explained, and the description thereof will not be repeated.

In this specification, the terms “print” and “printing” not only include the formation of significant information such as characters and graphics, but also broadly includes the formation of images, figures, patterns, and the like on a print medium, or the processing of the medium, regardless of whether they are significant or insignificant and whether they are so visualized as to be visually perceivable by humans.

Also, the term “print medium” not only includes a paper sheet used in common printing apparatuses, but also broadly includes materials, such as cloth, a plastic film, a metal plate, glass, ceramics, wood, and leather, capable of accepting ink.

Furthermore, the term “ink” (to be also referred to as a “liquid” hereinafter) should be extensively interpreted similar to the definition of “print” described above. That is, “ink” includes a liquid which, when applied onto a print medium, can form images, figures, patterns, and the like, can process the print medium, and can process ink. The process of ink includes, for example, solidifying or insolubilizing a coloring agent contained in ink applied to the print medium.

Furthermore, unless otherwise stated, the term “printing element” generally means a set of a discharge orifice, a liquid channel connected to the orifice and an element to generate energy utilized for ink discharge.

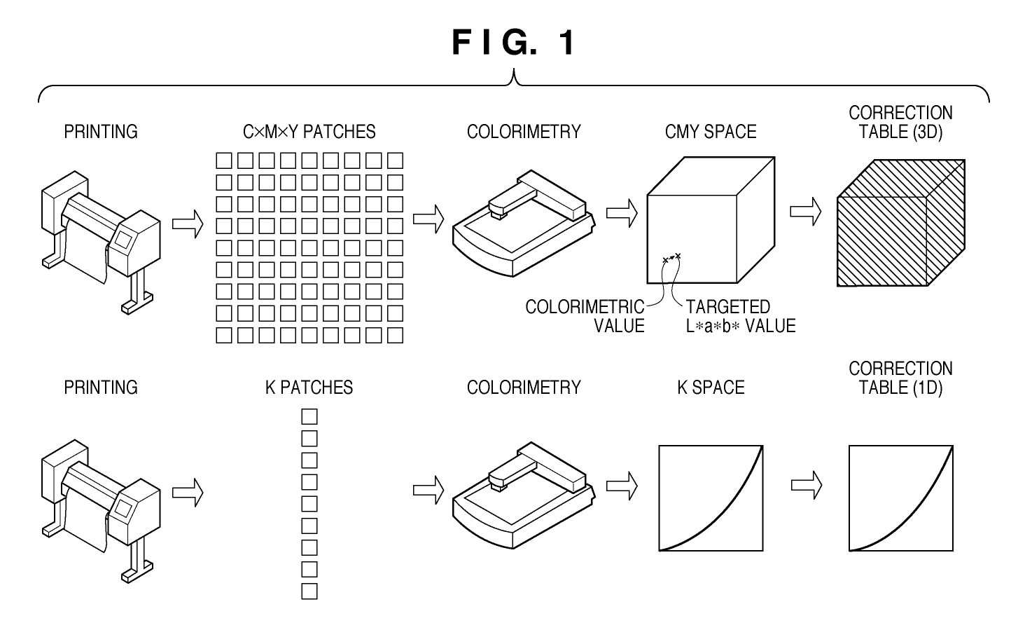

FIG. 1 is a view for conceptually explaining the feature of an embodiment according to the present invention.

In this embodiment, an inkjet printing apparatus, which prints on a large-size printing medium such as A0 or B0 paper, prints patches separately using achromatic and chromatic inks, measures them, and creates correction tables based on the calorimetric results.

The inkjet printing apparatus (to be referred to as a printing apparatus hereinafter) has a printhead which prints by discharging C (Cyan), M (Magenta), Y (Yellow), and K (blacK) inks. As printing media, the printing apparatus can use large-size printing media such as A0 and B0 print media.

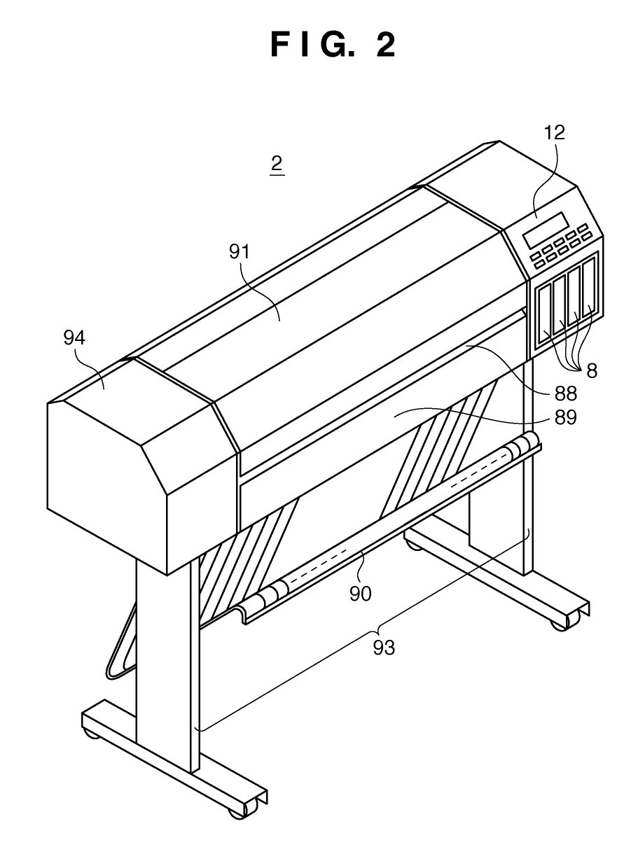

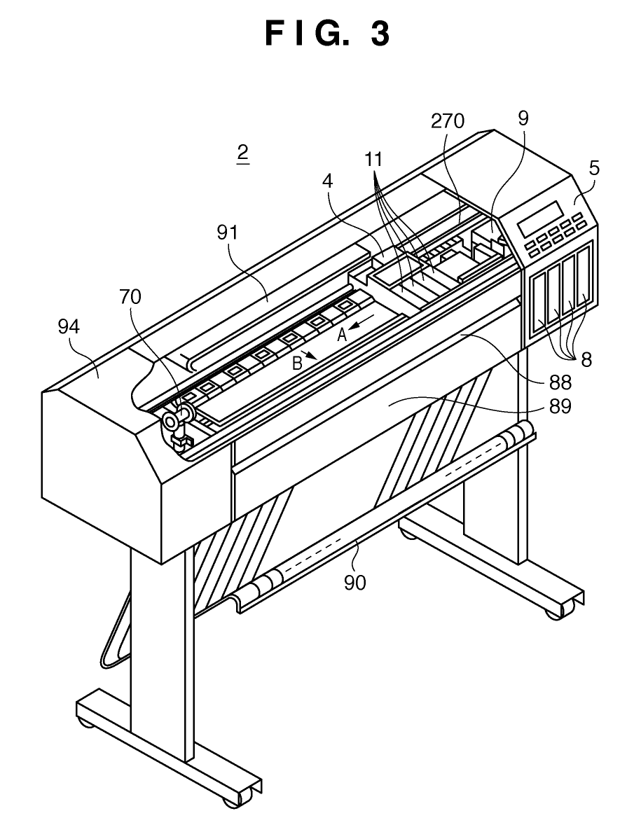

As is apparent from FIG. 1, the printing apparatus prints a plurality of chromatic patches using C (Cyan), M (Magenta), and Y (Yellow) inks, and outputs a patch sheet. A calorimeter measures the patch sheet, and plots calorimetric values in the CMY space. Based on the plotted values, the calorimeter creates a 3D correction table. The printing apparatus prints a plurality of achromatic patches using K (blacK) ink, and outputs a patch sheet. The calorimeter measures the patch sheet, and plots calorimetric values (colorimetrical color value) in the K space. Based on the plotted values, the calorimeter creates a 1D correction table.

<Description of Outline of Inkjet Printing Apparatus Main Body (FIGS. 2 and 3)>

FIG. 2 is a perspective view of the outer appearance of an inkjet printing apparatus as a typical embodiment of the present invention. FIG. 3 is a perspective view showing a state in which the upper cover of the inkjet printing apparatus shown in FIG. 2 is removed.

As shown in FIGS. 2 and 3, an inkjet printing apparatus (to be referred to as a printing apparatus hereinafter) 2 has a manual insertion port 88 on the front surface, and a roll paper cassette 89 which can open to the front side is arranged below the manual insertion port 88. A printing medium such as printing paper is supplied from the manual insertion port 88 or roll paper cassette 89 into the printing apparatus. The inkjet printing apparatus comprises an apparatus main body 94 supported by two legs 93, a stacker 90 which supports discharged printing media, and an openable see-through cover 91. An operation panel 12 and ink supply units 8 are arranged on the right side of the apparatus main body 94. A control unit 5 is arranged on the back side of the operation panel 12.

The printing apparatus 2 having this arrangement can print a large image in a poster size such as A0 or B0.

As shown in FIG. 3, the printing apparatus 2 comprises a conveyance roller 70 for conveying a printing medium in a direction (sub-scanning direction) indicated by an arrow B, and a carriage unit (to be referred to as a carriage hereinafter) 4 which is guided and supported to be able to reciprocate in a direction (indicated by an arrow A: main scanning direction) of the printing medium width. The carriage 4 receives a driving force from a carriage motor (not shown) via a carriage belt (to be referred to as a belt hereinafter) 270, and reciprocates in the direction indicated by the arrow A. An inkjet printhead (to be referred to as a printhead hereinafter) 11 is mounted on the carriage 4. A recovery unit 9 recovers discharge failures caused by clogging of the orifice of the printhead 11 or the like.

In this printing apparatus, the carriage 4 supports the printhead 11 made up of four heads in correspondence with four color inks, in order to print in color on a printing medium. That is, the printhead 11 is formed from a K (blacK) head for discharging K ink, a C (Cyan) head for discharging C ink, an M (Magenta) head for discharging M ink, and a Y (Yellow) head for discharging Y ink. In this structure, the ink supply unit 8 includes four ink tanks respectively storing K, C, M, and Y inks.

When printing on a printing medium by the above-described arrangement, the conveyance roller 70 conveys a printing medium to a predetermined print start position. Then, an operation to scan the printhead 11 by the carriage 4 in the main scanning direction, and an operation to convey the printing medium by the conveyance roller 70 in the sub-scanning direction are repeated, printing on the entire printing medium.

More specifically, the carriage 4 moves in the directions indicated by the arrow A shown in FIG. 3 by the belt 270 and carriage motor, printing on a printing medium. The carriage 4 then returns to a position (home position) before scanning, and the conveyance roller conveys the printing medium in the sub-scanning direction. After that, the carriage scans again in the directions indicated by the arrow A in FIG. 3, printing an image, character, or the like on the printing medium. After this operation is repeated to end printing of one printing medium, the printing medium is discharged into the stacker 90, completing printing of, for example, one A0-size printing medium.

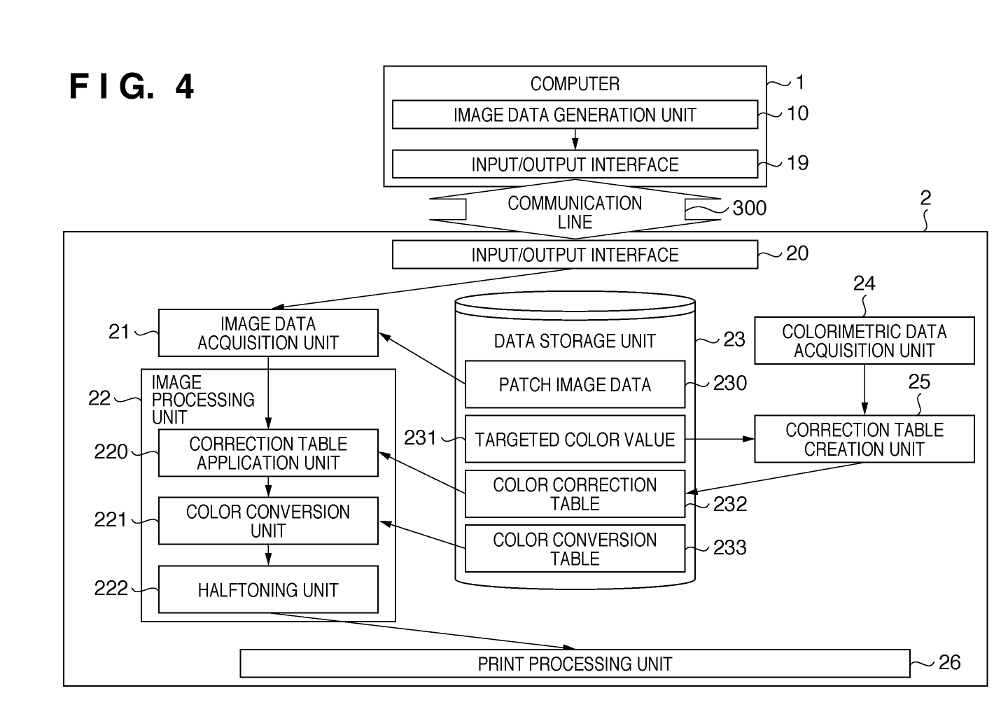

FIG. 4 is a block diagram showing the functional arrangement of the printing apparatus 2 and a host computer 1 which generates image data and transfers it to the printing apparatus described with reference to FIGS. 2 and 3.

The host computer (to be referred to as a computer hereinafter) 1 comprises an image data generation unit 10 and input/output interface 19. The image data generation unit 10 can generate image data represented by C, M, Y, and K values and special color component values.

The printing apparatus 2 comprises, as functions, an input/output interface 20 which receives image data, an image data acquisition unit 21 which acquires the image data, an image processing unit 22 which converts the acquired image data into print data, and a data storage unit 23 which stores data associated with image processing. Further, the printing apparatus 2 comprises a calorimetric data acquisition unit 24 which acquires calorimetric data, a correction table creation unit 25 which generates a correction table, and a print processing unit 26.

The data storage unit 23 is formed from, for example, a nonvolatile memory such as an EEPROM or FeRAM. The image data acquisition unit 21 is a buffer memory formed from a DRAM or SRAM. The image processing unit 22 and correction table creation unit 25 are electronic circuits formed from a CPU, ASIC, RAM, ROM, and the like.

The correction table can also be created by hardware using an ASIC and the like, or by causing the CPU to execute a predetermined program.

The image processing unit 22 comprises a correction table application unit 220, color conversion unit 221, and halftoning unit 222. The data storage unit 23 stores patch image data 230, a targeted color value 231, a color correction table 232, and a color conversion table 233.

The correction table application unit 220 applies the color correction table 232 stored in the data storage unit 23 to image data when printing an image. By using the color conversion table 233, the color conversion unit 221 converts color component data C, M, Y, and K of received image data into data representing the colors of inks used in the printing apparatus 2. Inks used in the printing apparatus 2 are four color inks of K (blacK), C (Cyan), M (Magenta), and Y (Yellow), as described above. However, the present invention is not limited to this arrangement, and is also applicable to an arrangement including a light-color ink or special color ink. The halftoning unit 222 converts multilevel data of each color component converted in correspondence with each ink into binary data which determines discharge/non-discharge of ink at each pixel.

The printing apparatus 2 in the embodiment is an inkjet printing apparatus. However, the printing apparatus can also be another one adopting an electrophotographic method or sublimation method, in addition to the inkjet printing apparatus.

The calorimetric data acquisition unit 24 may also take either an arrangement having an interface and input buffer for receiving calorimetric data measured using an external calorimeter, or an arrangement which integrates a calorimeter and inputs calorimetric data using the calorimeter. In either arrangement, the calorimeter irradiates a printed material by using a light source whose spectral reflectivity is known, and detects the reflected light to detect the spectral reflectivity of the printed material. Then, the calorimeter outputs a color value, for example, L*a*b* value or XYZ value.

A communication line 300 connects the computer 1 and printing apparatus 2. However, the communication line 300 is not limited to one connection form such as a dedicated cable, and may also take another connection form such as wireless connection, USB connection, or network connection.

The image processing unit 22, calorimetric data acquisition unit 24, and correction table creation unit 25 in the printing apparatus 2 need not always be arranged in the printing apparatus 2. For example, these functional units may also be arranged in the computer 1 or another apparatus in which the image processing unit 22 is operable. When the correction table creation unit 25 is arranged in the computer 1, data measured by the internal calorimeter of the printing apparatus 2 or an external calorimeter is input to the computer 1. The CPU of the computer 1 executes a program based on the targeted color value, patch image data, and calorimetric data, creating a correction table. If necessary, the correction table is transferred to the printing apparatus 2 via the communication line 300 or the like, and stored in the data storage unit 23.

Calibration processing executed in cooperation with the computer and printing apparatus having the above-described arrangement will be explained.

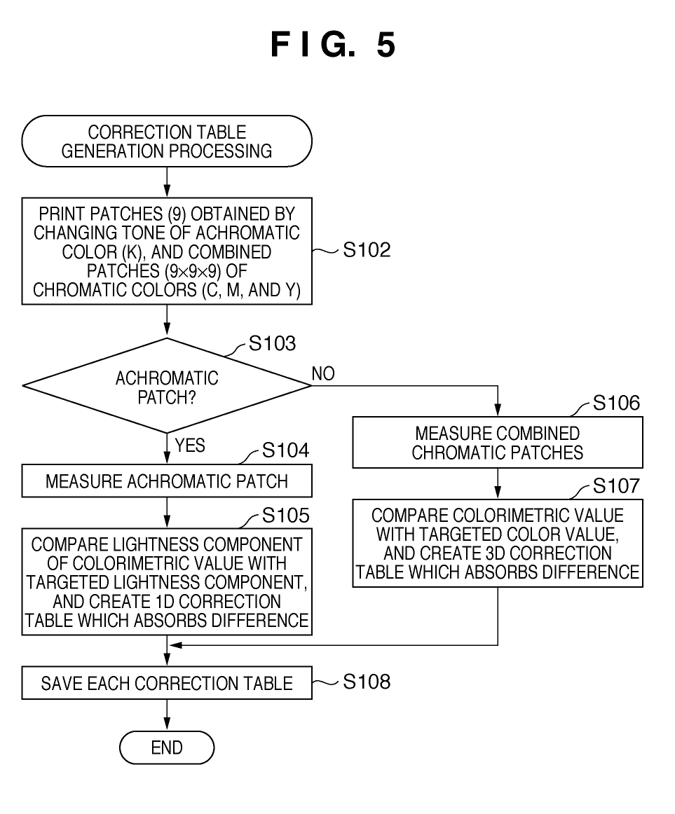

FIG. 5 is a flowchart showing correction table generation processing as the first stage of the calibration processing.

When execution of the calibration processing is designated, the correction table generation processing starts.

In step S102, the image data acquisition unit 21 prints an image based on the patch image data 230 stored in the data storage unit 23. The patch image data 230 is image data which represents each pixel of each color component with eight bits and takes a tone value of 0 to 255. The patch image data includes combined patches (9×9×9 patches) obtained by changing the tone value of each of the C, M, and Y components at intervals of 30, and patches (9 patches) obtained by changing the tone value of the K component at intervals of 30. The image processing unit 22 converts the readout patch image data 230 into print data, and the print processing unit 26 prints using the print data.

At this time, the correction table application unit 220 of the image processing unit 22 does not execute any processing.

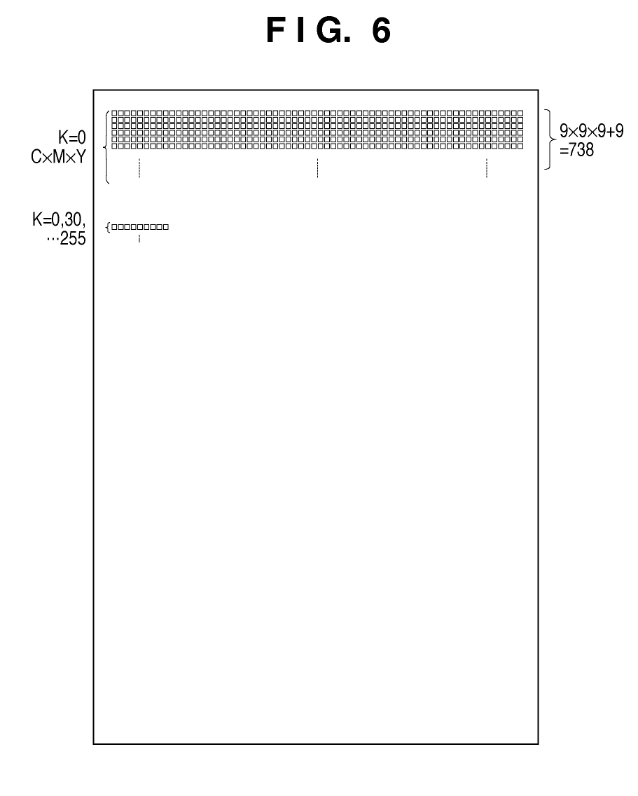

FIG. 6 is a view showing a printed patch image.

The number of printed patches is determined by C, M, and Y combined patches (chromatic patches) and K patches (achromatic patches), that is, 9×9×9+9=738 patches.

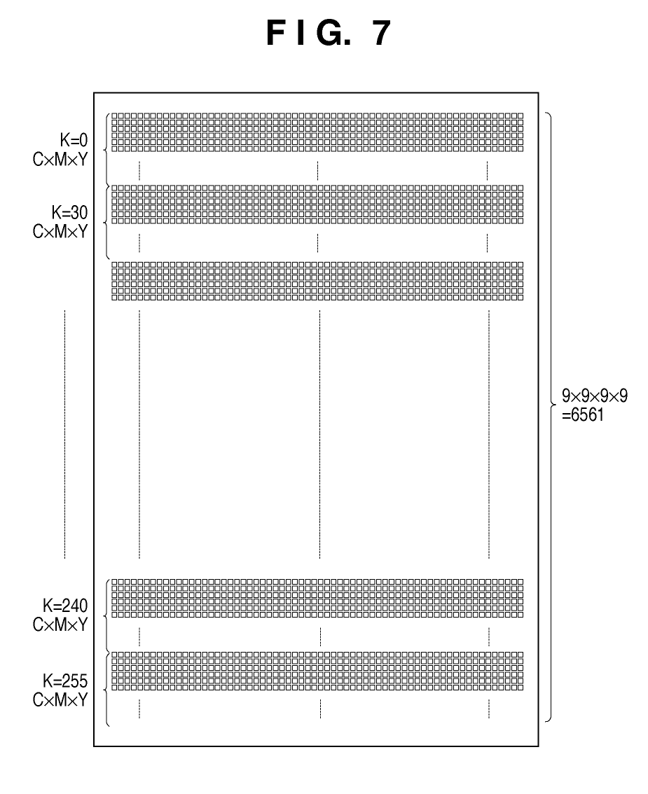

FIG. 7 is a view showing a patch image printed in conventional calibration processing.

The conventional calibration processing prints C, M, Y, and K combined patches, so the number of patch images is 9×9×9×9=6561, as shown in FIG. 7.

In step S103, it is determined whether the printed patch image is a chromatic or an achromatic patch. If the printed patch image is an achromatic patch, the process advances to step S104; if it is a chromatic patch, to step S106.

First, a correction table for chromatic colors (C, M, and Y) is created. For this purpose, the process advances to step S106 to measure chromatic patches and obtain colorimetrical color values (L*a*b*) corresponding to combined patches. In step S107, the colorimetrical color values are compared with the targeted color value 231 (L*a*b*) in the data storage unit 23, generating a 3D CMY→CMY correction table which absorbs differences. The targeted color value 231 is data of a color value which is obtained by outputting and measuring the patch image data 230 in the initial or normal state of the printing apparatus 2 and is set in advance in the data storage unit 23.

To create the CMY→CMY correction table, a colorimetrical color value needs to be converted into the targeted color value 231 in the CMY space. When there is no L*a*b* of the targeted color value 231 corresponding to the L*a*b* of the colorimetrical color value, the corresponding C, M, and Y are obtained by interpolation. The interpolation method suffices to be one that is, and for example, an interpolation method disclosed in Japanese Patent Laid-Open No. 2002-330302 is used.

Then, a correction table for the achromatic color (K) is created. For this purpose, the process advances from step S103 to step S104 to measure achromatic patches. For achromatic patches, a correction table regarding the color components (a*b*) is not required. Thus, in step S105, a K→K correction table is created from only the lightness component (L*).

Finally, the achromatic and chromatic color correction tables are saved as the color correction table 232 in the data storage unit 23.

For a printing apparatus which receives image data formed from C, M, Y, and K color components, a 3D CMY→CMY correction table is created for image data of the C, M, and Y chromatic components, and a 1D K→K correction table is created for image data of the K achromatic component.

Processing to print by applying the correction table will be explained as the second stage of the calibration processing.

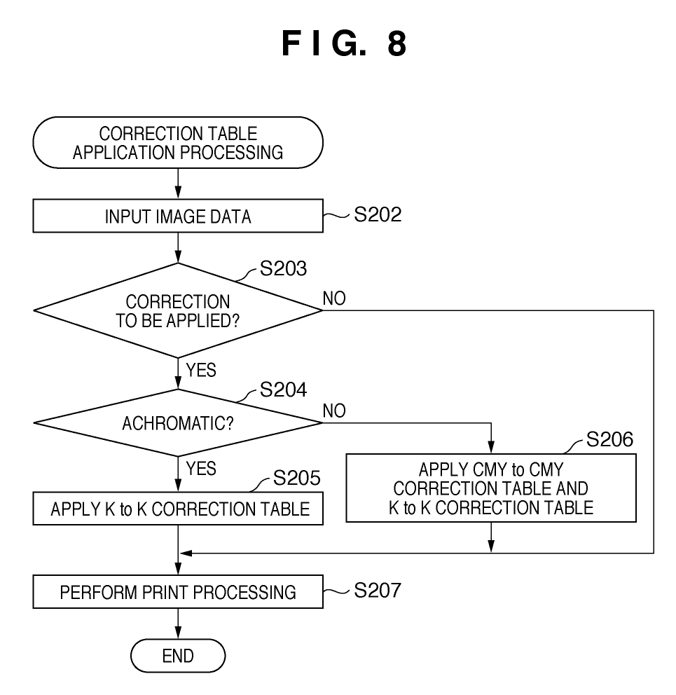

FIG. 8 is a flowchart showing the correction table application processing.

When image data is input from the computer 1 and an instruction to print is received from the computer 1 in step S202, it is determined in step S203 whether to apply correction. If it is determined to print an image without applying correction, the process advances to step S207 to simply execute print processing.

If it is determined to apply correction, the process advances to step S204 to determine the type of image data to which the correction is applied. If data to which correction is applied is achromatic data, the process advances to step S205 to apply a K→K correction table. If data to which correction is applied is chromatic data, the process advances to step S206 to apply a CMY→CMY correction table and further apply a K→K correction table. Details of the application will be described later.

After the correction table is applied, the process advances to step S207 to perform print processing.

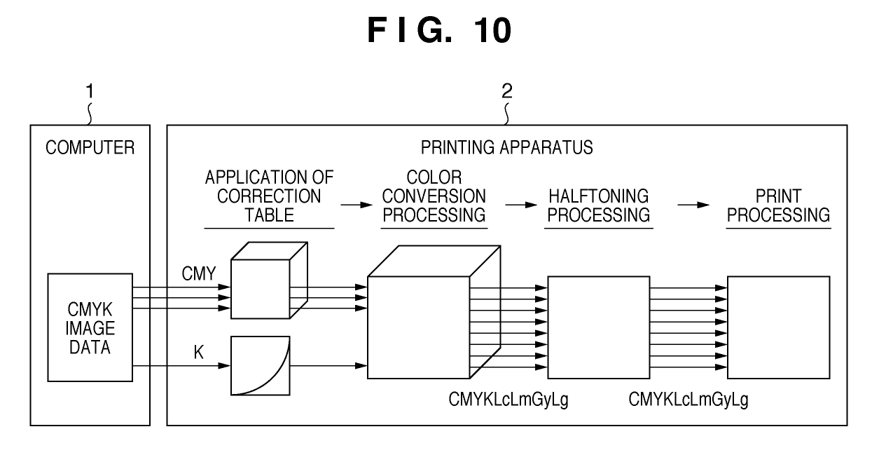

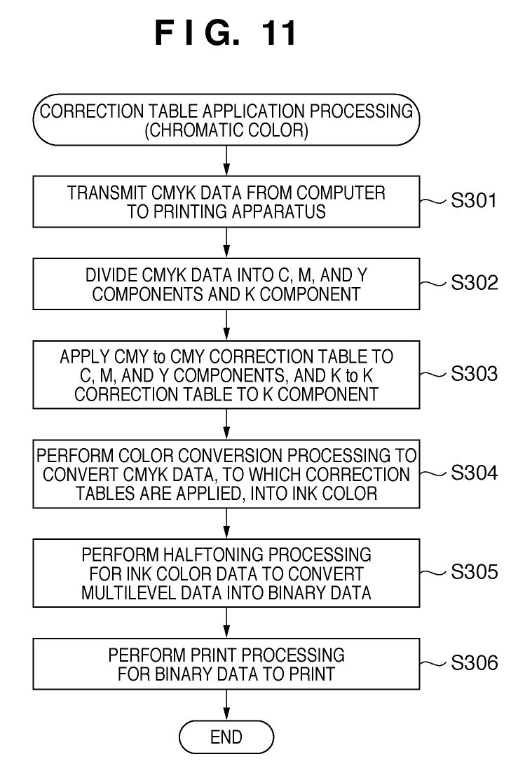

A correction table application method when processing chromatic data will be described in detail with reference to FIGS. 10 and 11 in association with step S206 of FIG. 8.

FIG. 10 is a block diagram showing a data flow associated with processing to apply a correction table to image data formed from chromatic data (C, M, and Y components) and achromatic data (K component).

FIG. 11 is a flowchart showing the correction table application processing shown in FIG. 10.

In step S301, the computer 1 transmits image data (CMYK image data) formed from C, M, Y, and K color components to the printing apparatus 2. The CMYK image data transmitted from the computer 1 to the printing apparatus 2 has undergone color matching processing to convert the color gamut of image data to be printed into a color gamut outputtable from the printing apparatus 2. For example, when image data to be printed is RGB image data or CMYK image data, the image data has undergone color conversion to an RGB→C, M, Y, and K in a color gamut printable by printing apparatus or to a CMYK→C, M, Y, and K in a color gamut printable by printing apparatus.

Steps S302 to S306 are processes in the printing apparatus 2.

In step S302, the transmitted CMYK image data is divided into C, M, and Y components and a K component for each pixel. In step S303, a 3D CMY→CMY correction table generated by the calibration processing is applied to the C, M, and Y component data divided in step S302. Also, a 1D K→K correction table is applied to the divided K component data.

In step S304, the C, M, and Y component data and K component data corrected by applying the correction tables are concatenated into CMYK image data. The CMYK image data undergoes color conversion processing, converting it into each component data (ink color data) representing an ink color. In step S305, halftoning processing is performed to convert each multilevel ink color data into binary data which determines discharge/non-discharge of ink, obtaining each binary ink color data.

In step S306, print processing is performed using each binary ink color data, and the printhead discharges ink, printing on a desired printing medium.

Note that the color conversion processing, halftoning processing, and print processing in steps S304, S305, and S306 use known techniques, and a detailed description thereof will be omitted.

The above-described embodiment can execute calibration processing to separately calibrate chromatic and achromatic colors at two stages, that is, generation of correction tables and application of them. Since chromatic and achromatic colors are separately calibrated, the number of necessary patches can be reduced much more than in the conventional technique. Therefore, while maintaining a predetermined precision, the time and labor for calibration can be saved.

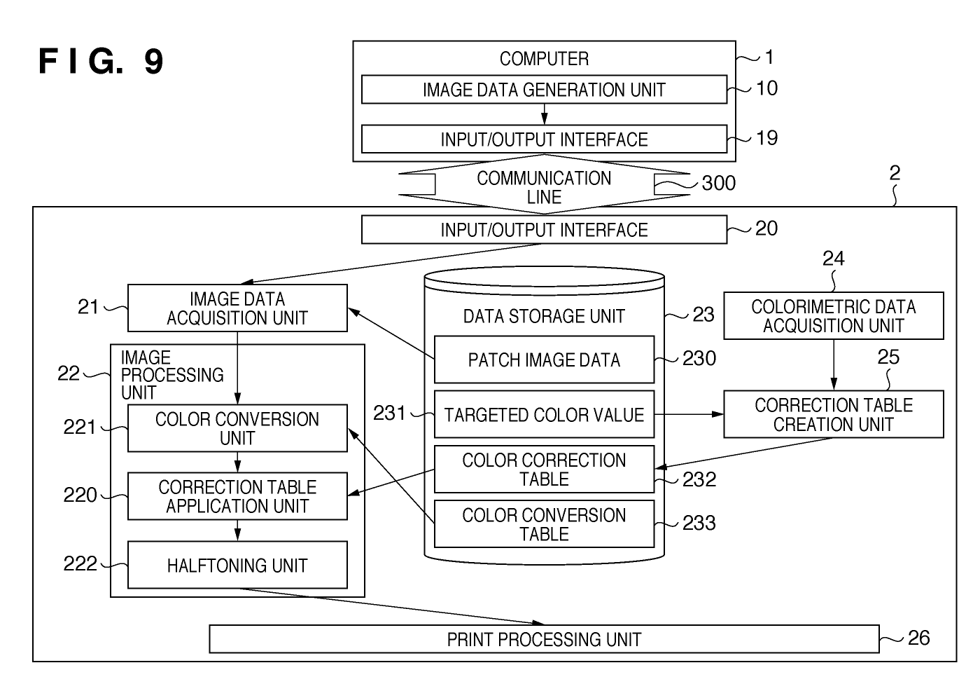

In the functional block diagram shown in FIG. 4, the correction table application unit 220 is connected to the input of the color conversion unit 221. However, the present invention is not limited to this. For example, the correction table application unit 220 may be connected to the output of the color conversion unit 221, as shown in the functional block diagram of FIG. 9. In this manner, the correction table can also be applied not only to image data of C, M, Y, and K color components received from a computer, but also to color-converted print data of C, M, Y, and K color components corresponding to the respective ink colors of a printing apparatus.

In addition, by changing data to which the correction table is applied, a correction table for print data corresponding to a chromatic ink and that for print data corresponding to an achromatic ink can be separated in a printing apparatus using various inks. For example, calibration can be performed separately for C, M, Y, light cyan (Lc), light magenta (Lm), red (R), green (G), and blue (B) chromatic colors, and K, gray (Gy), and light gray (Lg) achromatic colors.

In this case, 9⁸ patches are printed and measured for the chromatic colors. Further, a chromatic color correction table for correcting differences from the targeted color value 231 is created. For the achromatic colors, 9³ patches are printed and measured. Further, an achromatic color correction table for correcting differences from the targeted color value 231 is created. A method of creating the targeted color value 231 and a method of generating a correction table are the same as those in the above-described embodiment. The number of dimensions of the correction table is eight (8) for the chromatic colors and three (3) for the achromatic colors in accordance with the number of inks.

With these settings, the present invention is applicable to even the chromatic and achromatic components of print data representing the tones of coloring materials in correspondence with respective ink colors after color conversion.

The above-described embodiment can achieve high-density, high-resolution printing by using, among inkjet printing methods, a method which uses a means (e.g., an electrothermal transducer) for generating heat energy to discharge ink and changes the ink state by heat energy.

In addition, the form of the inkjet printing apparatus according to the present invention may also be the form of an image output apparatus for an information processing apparatus such as a computer, the form of a copying machine combined with a reader, or the form of a facsimile apparatus having transmission and reception functions.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-234711, filed Sep. 10, 2007, which is hereby incorporated by reference herein in its entirety.

What is claimed is:

1. A method of calibrating a printing apparatus which prints an image on a printing medium based on image data, the method comprising:
a printing step of printing a plurality of chromatic patches representing different tone values by changing a value of a chromatic component of the image data, and a plurality of achromatic patches representing different tone values by changing a value of an achromatic component of the image data;
a calorimetric step of measuring the plurality of chromatic patches and the plurality of achromatic patches printed in the printing step;
a correction table creation step of separately creating a there dimensional (3D) chromatic color correction table for correcting differences between calorimetric values obtained from the plurality of chromatic patches measured in the calorimetric step and a preset targeted color value, and a one dimensional (1D) achromatic color correction table for correcting differences between calorimetric values obtained from the plurality of achromatic patches measured in the calorimetric step and a preset targeted color value;
a determination step of determining whether or not image data used to print is data formed from chromatic data and achromatic data, or achromatic data;
a correction step of correcting the image data used to print by using both the 3D chromatic color correction table and the 1D achromatic color correction table in a case where it is determined in the determination step that the image data used to print is data formed from chromatic data and achromatic data, or by using only the 1D achromatic color correction table in a case where it is determined that the image data used to print is achromatic data; and
a printing step of printing an image on a printing medium based on the image data corrected in the correction step.

2. The method according to claim 1, wherein
the chromatic component includes a cyan (C) component, magenta (M) component, and yellow (Y) component of the image data, and
the achromatic component includes a black (K) component of the image data.

3. The method according to claim 2, wherein
the 1D achromatic color correction table is a correction table defined by the black (K) component, and
the 3D chromatic color correction table is a correction table defined by the cyan (C) component, the magenta (M) component, and the yellow (Y) component.

4. The method according to claim 1, wherein the targeted color value uses a calorimetric value acquired in a normal state or initial state of the printing apparatus.

5. A printing apparatus which performs correction by applying a calibration method according to claim 1 and prints, the apparatus comprising:
storage means for storing the 3D chromatic color correction table and the 1D achromatic color correction table;
input means for inputting image data from a host computer;
determination means for determining whether the image data is data formed from chromatic data and achromatic data, or achromatic data;
correction means for performing correction by using the 1D achromatic color correction table and the 3D chromatic color correction table in a case where it is determined by said determination means that the image data is data formed from chromatic data and achromatic data, or by using only the 1D achromatic color correction table in a case where it is determined by said determination means that the image data is achromatic data;
conversion means for converting the image data corrected by said correction means into print data corresponding to coloring materials used in the printing apparatus; and
printing means for printing by using the print data obtained by the conversion by said conversion means.

6. The apparatus according to claim 5, wherein
the printing apparatus includes an inkjet printing apparatus, and
inks used to print includes inks of cyan (C), magenta (M), yellow (Y), light cyan (Lc), light magenta (Lm), red (R), green (G), blue (B), black (K), gray (Gy), and light gray (Lg).

7. A method of calibrating a printing apparatus which prints an image on a printing medium based on image data, the method comprising:
a printing step of printing a plurality of chromatic patches representing different tone values by changing a value of a chromatic component of the image data, and a plurality of achromatic patches representing different tone values by changing a value of an achromatic component of the image data;
a calorimetric step of measuring the plurality of chromatic patches and the plurality of achromatic patches printed in the printing step;
a correction table creation step of separately creating a multidimensional chromatic color correction table for correcting differences between calorimetric values obtained from the plurality of chromatic patches measured in the calorimetric step and a preset targeted color value, and a one dimensional (1D) achromatic color correction table for correcting differences between calorimetric values obtained from the plurality of achromatic patches measured in the calorimetric step and a preset targeted color value;
a division step of dividing image data used to print into chromatic data and achromatic data;
a correction step of correcting the image data by applying the multidimensional chromatic color correction table to the calorimetric data divided in the division step, and the 1D achromatic color correction table to the achromatic data divided in the division step; and
a printing step of printing an image on a printing medium based on the image data corrected in the correction step.

8. A printing apparatus which performs correction by applying a calibration method according to claim 7 and prints, the apparatus comprising:
storage means for storing the multidimensional chromatic color correction table and the 1D achromatic color correction table;
input means for inputting image data from a host computer;
division means for dividing the image data into chromatic data and achromatic data;
correction means for correcting the image data by applying the multidimensional chromatic color correction table to the calorimetric data divided by said division means, and the 1D achromatic color correction table to the achromatic data divided by said division means;
conversion means for converting the image data corrected by said correction means into print data corresponding to coloring materials used in the printing apparatus; and
printing means for printing an image on a printing medium based on the print data obtained by the conversion by said conversion means.
